(19) United States
(12) Patent Application Publication
(10) Pub. No.: US 2005/0238852 A1
(43) Pub. Date: Oct. 27, 2005

(54) Optical products for displays

(76) Inventors: Naoki Nakayama, Tendo-City (JP); Kazuyoshi Konta, Nishimurayama-gun (JP); Anthony J. Freking, Vadnais Heights, MN (US)

Correspondence Address: 3M INNOVATIVE PROPERTIES COMPANY, PO BOX 33427, ST. PAUL, MN, 55133-3427, US

(21) Appl. No.: 10/830,733

(22) Filed: Apr. 23, 2004

(51) Int. Cl. B32B 3/02

(52) U.S. Cl. 428/192

(57) ABSTRACT

An optical sheet is comprised of an optical film laminated onto an adhesive layer. The perimeter of the adhesive layer is inset from the perimeter of the optical film. Multiple optical films may be stacked onto each other to form an optical sheet set that efficiently assembles into an optical display. The optical sheet set has no exposed adhesive, which tends to collect dust and particles or transfer to other parts of the display.

### BACKGROUND OF THE INVENTION

The present invention relates to optical films. In particular, the present invention relates to optical sheets formed by bonding adhesive to optical films.

Optical films are used to increase the amount of light exiting an optical display in a direction normal, or “on-axis,” to the surface of the display. Increasing the amount of on-axis light reduces the amount of energy required to generate a desired amount of on-axis luminance. This is particularly important for optical displays that use battery powered light sources such as those used in laptop computers, calculators, digital wristwatches, cellular phones, and personal digital assistants.

The 3M brand Brightness Enhancement Film is used to address this problem. The film collects light from “off-axis” and redirects or “recycles” this light on-axis toward the viewer. In use, this material increases the on-axis luminance at the expense of off-axis luminance.

A “turning” film is also used to increase the amount of on-axis light exiting a display. Turning films are usually used in combination with a wedge-shaped light guide. Light rays exiting the light guide at the glancing angle, usually less than 30° to the output surface, are internally reflected such that they are directed substantially on-axis. Representative embodiments of turning films are described in U.S. Pat. Nos. RE 38,243 and 4,984,144.

Another film used to increase on-axis light exiting a display is a multilayer polymer film such as DBEF from 3M Company. The film is formed of about 700 to 800 layers of polymer each having about 150 nm thickness and provides high reflectivity over a wide bandwidth. Representative embodiments are described in U.S. Pat. No. 6,613,421.

Other films, such as diffuser-type films, along with the films described above, are used extensively in optical displays. Multiple films are arranged between the optical light guide and liquid crystal panel of a liquid crystal display (LCD), and it is difficult and inefficient to insert each film individually. This is especially true for small displays.

In addition, these films have a structured surface that is fragile and easily damaged and must be protected until the films are assembled into a display. To prevent scratching or other damage prior to assembly in a display, a protective cover, or pre-mask, is laminated to the film to protect the structured surface. Placing and then removing the pre-mask from each film are added steps in the manufacture of displays, which increases the cost and time required for assembly.

### BRIEF SUMMARY OF THE INVENTION

The present invention is an optical sheet and a method of making the optical sheet. The optical sheet includes an optical film laminated onto an adhesive layer. The perimeter of the adhesive layer is inset from the perimeter of the optical film so that no adhesive is exposed to collect dust and particles or to transfer to other films or components of an optical display.

### BRIEF DESCRIPTION OF THE DRAWINGS

FIG. 1 is a front view of a representative embodiment of an optical sheet set for use in a display in accordance with the present invention.

FIG. 2 is a cross-sectional side view of a representative embodiment of an optical sheet set for use in a display in accordance with the present invention.

FIG. 3 is a top view of a representative embodiment of an optical sheet.

FIG. 4 is a top view of a representative alternate embodiment of an optical sheet.

FIGS. 5a and 5b are top views and FIGS. 5c, 5d, and 5e are cross-sectional side views illustrating a method of making an optical sheet in accordance with the present invention.

FIG. 5f is a side view illustrating a method of making optical sheet sets in accordance with the present invention.

### DESCRIPTION

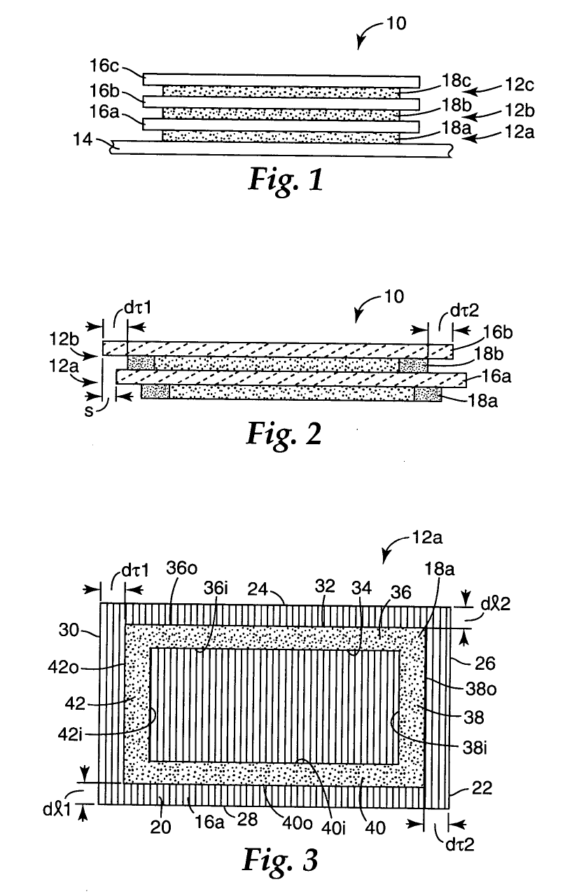

FIG. 1 shows an optical sheet set in accordance with the present invention. FIG. 1 is a front view of an optical sheet set 10 for use in displays. As shown, optical sheet set 10 includes three optical sheets 12a, 12b, and 12c and is carried by liner 14. Optical sheet 12a includes optical film 16a and adhesive layer 18a, optical sheet 12b includes optical film 16b and adhesive layer 18b, and optical sheet 12c includes optical film 16c and adhesive layer 18c. Adhesive layer 18a is laminated onto liner 14, and optical films 16a, 16b, and 16c are laminated, in alternating fashion, with adhesive layers 18b and 18c.

In use, optical sheet set 10 is removed from liner 14 and assembled into an optical display, such as an LCD, between the optical light guide and liquid crystal panel. Laminating the optical films together prior to installation into an optical display decreases the time and cost associated with assembly of the optical display by avoiding individually inserting each film. Installation of optical sheet set 10 into an optical display can also be performed using an automated assembly line. Optical sheet set 10 can also reduce the amount of debris between films and reduce damage to the films.

Although optical sheet set 10 is shown having three optical films, the number of optical films varies depending on the display in which it is used. Some or all of the optical films may be of the same type, again, depending on the optical display. Examples of the types of optical films that may be used in the present invention include light directing films, turning films, multilayer polymer films, diffuser-type films, etc. In addition, the presence of adhesive layer 18a is optional.

FIG. 2 is a cross-sectional side view of optical sheet set 10 having only two optical films for simplicity. Optical sheet set 10 includes optical sheet 12a with film 16a and adhesive layer 18a and optical sheet 12b with film 16b and adhesive layer 18b. FIG. 2 includes distances dτ1 and dτ2, which is shown as the distance between the edges of film 16b and the edges of adhesive layer 18b. Distances dτ1 and dτ2 are representative of the corresponding distances for any optical sheet. Also shown is shift length S, which is the distance between the edges of films 16a and 16b. Shift length S is also representative of the corresponding shift length between any pair of adjacent films.

Optical sheets 12a and 12b are initially made individually in a process that is described below. Once made, optical sheet 12b is laminated onto optical sheet 12a, which requires aligning the edges of film 16b with the edges of film 16a. As shown in FIG. 2, the process of alignment is imperfect, and often the optical sheets are misaligned by some distance. The misalignment is shown here as shift length S. However, the present invention is advantageous even when there is no misalignment between the optical sheets.

If an adhesive layer were applied all the way to the edges of the optical films, any misalignment during stacking of the optical sheets would result in exposed adhesive along the edges. The exposed adhesive presents two problems. First, dust and particles collect on the exposed adhesive, and second, the exposed adhesive is easily transferred to other optical films or parts of the display, which may interfere with viewing.

The present invention avoids these problems by recessing the outer edges of the adhesive layers from the edges of the optical films. In FIG. 2, the edges of adhesive layer 18b are recessed from the edges of optical film 16b by distances dτ1 and dτ2. Distances dτ1 and dτ2 are preferably between about 0.1 mm to about 1.0 mm and most preferably between about 0.1 mm to about 0.5 mm. To be effective, however, distances dτ1 and dτ2 must be longer than shift length S.

FIG. 3 is a top view of optical sheet 12a. Optical sheet 12a includes optical film 16a with structured surface 20 and perimeter 22. Optical film 16 also includes longitudinal edge 24, transverse edge 26, longitudinal edge 28, and transverse edge 30. Optical sheet 12a further includes adhesive layer 18a with outer perimeter 32 and inner perimeter 34. Adhesive layer 18a is also shown having frame side 36 with outer edge 36o and inner edge 36i, frame side 38 with outer edge 38o and inner edge 38i, frame side 40 with outer edge 40o and inner edge 40i, and frame side 42 with outer edge 42o and inner edge 42i. FIG. 3 further shows distances dτ1, dτ2, dl1, and dl2. Distance dτ1 is the distance outer edge 42o is inset from transverse edge 30 and, distance dτ2 is the distance outer edge 38o is inset from transverse edge 26. Distance dl1 is the distance outer edge 40o is inset from longitudinal edge 28, and distance dl2 is the distance outer edge 36o is inset from longitudinal edge 24.

Adhesive layer 18a has a frame-type shape such that it will not interfere with the viewing area of optical film 16a. However, it is not required that adhesive layer 18a include all of frame sides 36, 38, 40, and 42. Adhesive layer 18a may include any combination of one or more of, or portions of, frame sides 36, 38, 40, and 42 and be effective. In fact, there is no specific shape requirement for adhesive layer 18a. In addition, adhesive layer 18a is laminated to structured surface 20 of film 16a. Structured surface 20 contains arrays of prism elements for directing light. Prism elements are fragile and require protection prior to installation of the optical film into an optical display, usually by the addition of a pre-mask. However, when optical sheet 12a is laminated to liner 14 or to another optical sheet, structured surface 20 is protected, which circumvents applying the protective cover or pre-mask to structured surface 20. This benefit provides further time and cost savings in the manufacturing process. Adhesive layer 18a may also be applied to the smooth surface of film 16a, opposite structured surface 20, if preferred.

The limitations and preferred ranges of distances dτ1 and dτ2 were described in reference to FIG. 2. Those limitations and preferred ranges are also applicable to distances dl1 and dl2. Distances dτ1, dτ2, dl1, and dl2 may or may not be equal for each optical sheet. For example, distance dτ1 may or may not be equal to distance dτ2, and distance dl1 may or may not be equal to distance dl2. Thus, distances dτ1, dτ2, dl1, and dl2 must be longer than shift length S but may all be different from one another.

The present invention may also be described in terms of the perimeters of optical film 16a and adhesive layer 18a. Referring, again, to FIG. 3, outer perimeter 32 of adhesive layer 18a is inset from perimeter 22 of optical film 16a. Inner perimeter 34 of adhesive layer 18a is inset from perimeters 22 and 32. Again, the distance between perimeter 22 and outer perimeter 32 may vary but must be longer than shift length S.

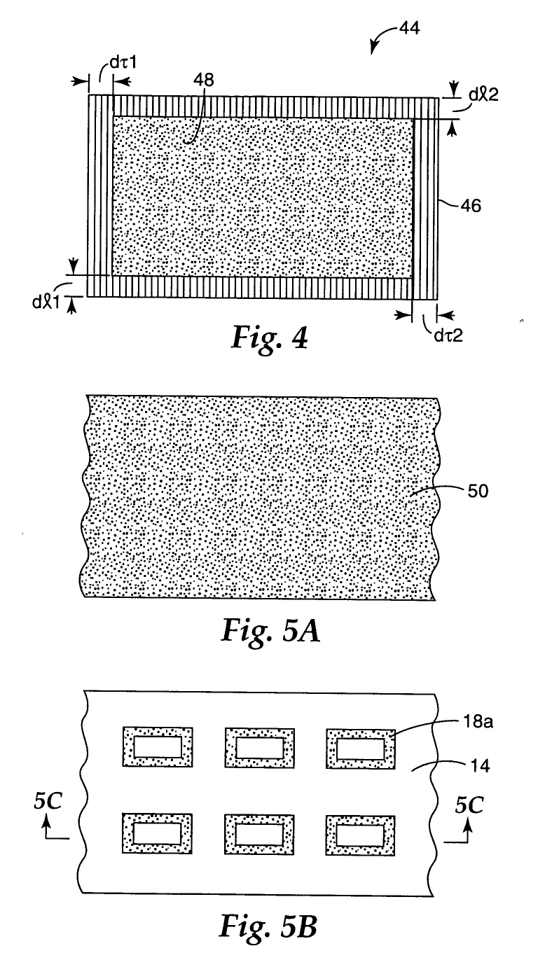

FIG. 4 is a top view of an alternate embodiment of an optical sheet 44. Optical sheet 44 includes optical film 46 and adhesive layer 48. FIG. 4 additionally shows distances dτ1, dτ2, dl1, and dl2, which have the identical limitations and preferred ranges as those discussed above.

Here, adhesive layer 48 does not have a frame-type shape. This embodiment may only be used with adhesives that do not interfere with viewing of the optical display.

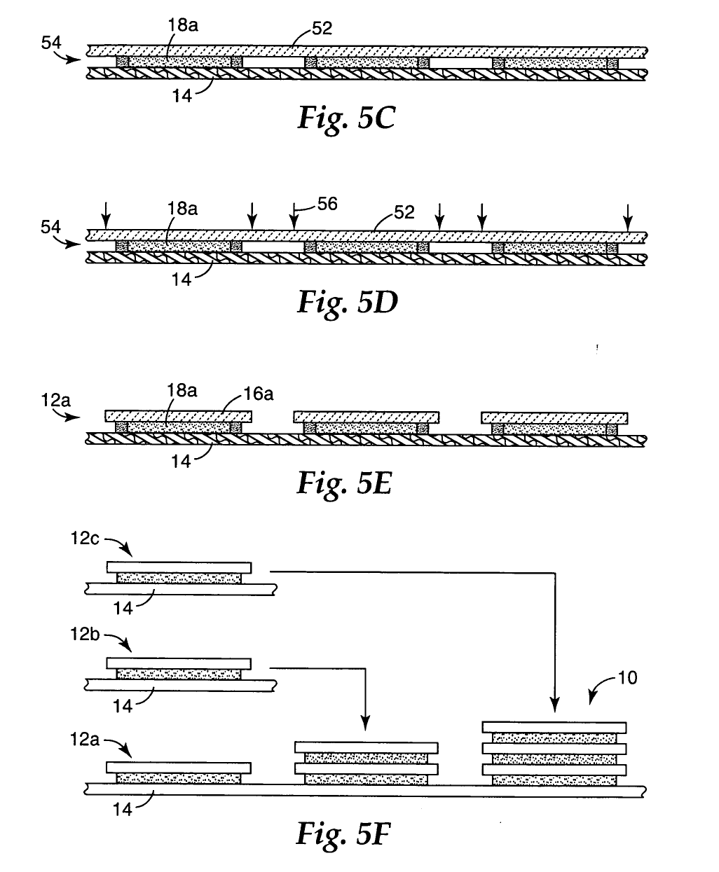

FIGS. 5a through 5e show a method of making the present invention. FIG. 5a is a top view showing adhesive material 50 bonded to a liner. Adhesive material 50 preferably but not necessarily is a plastic adhesive and may be, for example, double-sided tape laminated onto the liner, liquid adhesive coated on the liner, or any of a number of forms of bonding an adhesive to a liner.

FIG. 5b is a top view of the formation of adhesive layer 18a laminated to liner 14. Adhesive material 50 is kiss-cut, and the waste material is stripped away. Any of a number of different methods of kiss-cutting may be carried out in order to form adhesive layer 18a. For example, cuts to form the outer perimeter and the inner perimeter may be carried out concurrently or separately. Alternatively, adhesive layer 18a may be applied directly to liner 14. FIG. 5b also illustrates that multiple adhesive layers 18a can be made simultaneously.

A cross-sectional side view through line 5c-5c of FIG. 5b is shown is FIG. 5c. Here, optical film material 52 is laminated to adhesive layers 18a to form intermediate material 54. Alternatively, adhesive layers 18a may be applied to optical film material 52 before being applied to liner 14.

FIG. 5d is a cross-sectional side view illustrating the position of die cuts 56 through optical film material 52. As shown, die cuts 56 are made a distance beyond the edges of adhesive layer 18a.

FIG. 5e is another cross-sectional side view illustrating the result of cutting optical film material 52 with die cuts 56, and stripping the waste material away to form optical film 16a. Optical film 16a is laminated to adhesive layer 18a resulting in optical sheets 12a. These are in turn laminated to liner 14. Alternatively, adhesive layer 18a may be applied directly to optical film 16a.

Optical sheets 12a may subsequently be laminated together or to other optical sheets, such as optical sheets 12b and 12c, to form optical sheet sets 10. FIG. 5f is a side view illustrating the formation of optical sheet set 10 by stacking three optical sheets. Optical sheet 12a forms the bottom layer and maintains contact with liner 14. Optical sheet 12b is removed from its liner 14 and stacked on top of optical sheet 12a. Optical sheet 12c is then removed from its liner 14 and stacked on top of optical sheet 12b.

As discussed above, an important benefit of the present invention is the avoidance of exposed adhesive, which is detrimental to the display. The following examples illustrate the effectiveness of the present invention.

### EXAMPLE

An optical sheet set formed from three optical sheets was produced by the method of the present invention. The bottom and middle optical sheets included Thin-BEF by 3M Company, and the top optical sheet included DBEF by 3M Company. Double-sided tape, such as Sumitomo 3M #4040 or #4037, formed the adhesive layer. Each film measured 40mm×50 mm. The adhesive layers had a frame-type shape with a 1 mm strip extending around the films. The outer perimeters of each adhesive layer were recessed by a distance of about 0.5 mm from the perimeters of the films.

The optical sheet set was exposed to room conditions (23° C., 50% relative humidity). After seven days, the appearance of the edges was checked. There was no dust or particle accumulation at the edges.

Next, the optical sheet set was positioned between glass plates, and a 500 g weight was placed on top. The sample was stored at 65° C. and 95% relative humidity. After three days, the glass plates were checked. There was no adhesive transferred to the glass plates.

### COMPARISON EXAMPLE

A second optical sheet set was produced that was identical to the previous example except that the adhesive layers were not recessed from the edges of the films. Instead, the outer perimeters of the adhesive layers were aligned with the perimeters of each film.

This optical sheet set was exposed to the identical conditions as described for the previous example. Here, however, dust and particles attached to exposed adhesive on the edges, adhesive transferred to the glass plates, and the optical sheets adhered to the glass plates.

In addition to the advantages illustrated by these examples, the present invention provides a way to efficiently assemble multiple optical films into an optical display. A pre-mask is no longer required, and multiple films can be installed simultaneously. This reduces the time and cost associated with manufacturing optical displays, which is desirable to the manufacturer.

Although the present invention has been described with reference to preferred embodiments, workers skilled in the art will recognize that changes may be made in form and detail without departing from the spirit and scope of the invention.

1. A method of making an optical product, the method comprising:
cutting an adhesive material to form an adhesive layer, the adhesive layer having a first length and a first width;
bonding a surface of an optical film material to the adhesive layer to form an intermediate material; and
cutting essentially only the optical film material of the intermediate material to form an optical sheet that includes an optical film and the adhesive layer, the optical film of the optical sheet having a second length larger than the first length and a second width larger than the first width.

2. The method of claim 1 and further comprising:
stripping waste adhesive material surrounding the adhesive layer; and
stripping waste optical film material surrounding the optical film.

3. The method of claim 1 wherein a plurality of optical sheets are made concurrently.

4. The method of claim 1 and further comprising:
layering the adhesive material onto a liner.

5. The method of claim 1 wherein the adhesive layer has a frame-type shape.

6. The method of claim 1 wherein the adhesive layer has a portion of a frame-type shape.

7. The method of claim 1 wherein the surface of the optical film material is a structured surface.

8. The method of claim 1 and further comprising:
making a plurality of optical sheets; and
stacking the plurality of optical sheets to form an optical sheet set.

9. The method of claim 8 wherein the optical sheet set is formed with a plurality oftypes of optical film.

10. A method of making an optical product, the method comprising:
cutting an adhesive material to form an adhesive layer, the adhesive layer having a frame-type shape with a first perimeter;
laminating an optical film material to the adhesive layer; and
cutting the optical film material to form an optical sheet, the optical sheet including the adhesive layer and an optical film, the optical film having a second perimeter, the first perimeter of the adhesive layer being inset from the second perimeter of the optical film.

11. The method of claim 10 wherein the adhesive material is double-sided tape.

12. The method of claim 10 wherein the optical film material has a structured surface.

13. The method of claim 10 wherein the inset is a distance of between about 0.1 mm to about 1.0 mm.

14. The method of claim 10 wherein the inset is a distance of between about 0.1 mm to about 0.5 mm.

15. The method of claim 10 and further comprising:
layering the adhesive material onto a liner.

16. The method of claim 10 and further. comprising:
making a plurality of optical sheets; and
stacking the plurality of optical sheets to form an optical sheet set.

17. The method of claim 16 wherein the optical films are selected from a plurality of different types of optical films.

18. A method of making an optical product, the method comprising:
applying an adhesive layer to a liner;
bonding a surface of an optical film material to the adhesive layer; cutting essentially only the optical film material to form an optical sheet, which includes an optical film and the adhesive layer, the optical film having at least one edge; and
wherein the adhesive layer is inset from the at least one edge of the optical film.

19. The method of claim 18 and further comprising:
stripping waste optical film material surrounding the optical film.

20. The method of claim 18 and further comprising:
making a plurality of optical sheets; and
stacking the plurality of optical sheets to form an optical sheet set.

21. The method of claim 20 wherein the inset is a distance that is larger than a shift length of misalignment between adjacent optical sheets.

22. The method of claim 20 wherein the inset is a distance of at least 0.1 mm.

23. A method of making an optical sheet, the method comprising:
applying an adhesive layer to an optical film having at least one edge; and
wherein the adhesive layer is inset from the at least one edge of the optical film.

24. The method of claim 23 wherein the inset is a distance of at least 0.1 mm.

25. An optical sheet comprising:
an adhesive layer having edges and a first length and a first width;
an optical film contacting the adhesive layer, the optical film having edges and a second length larger than the first length and a second width larger than the first width; and
wherein the edges of the adhesive layer are recessed from the edges of the optical film.

26. The optical sheet of claim 25 wherein the adhesive layer has a frame-type shape.

27. The optical sheet of claim 25 wherein the adhesive layer has a portion of a frame-type shape.

28. The optical sheet of claim 25 wherein distances between the first and second lengths and distances between the first and second widths are between about 0.1 mm to about 1.0 mm.

29. The optical sheet of claim 25 wherein distances between the first and second lengths and distances between the first and second widths are between about 0.1 mm to about 0.5 mm.

30. The optical sheet of claim 25 wherein the optical film is selected from the group consisting of light directing films, turning films, diffuser-type films, and multilayer optical films.

31. The optical sheet of claim 25 wherein the adhesive layer is double-sided tape.

32. An optical sheet comprising:
an optical film having an outer perimeter; and
an adhesive layer stacked underneath the optical film, the adhesive layer having an outer perimeter inset from the outer perimeter of the optical film.

33. The optical sheet of claim 32 wherein the optical film has a structured surface.

34. The optical sheet of claim 33 wherein the adhesive layer contacts the structured surface of the optical film.

35. The optical sheet of claim 32 and further comprising:
a liner stacked underneath the adhesive layer.

36. An optical sheet set comprising:
a plurality of optical films having outer perimeters;
a plurality of adhesive layers having outer perimeters inset from the outer perimeters of the optical films, and inner perimeters inset from the outer perimeters of the adhesive layers; and
wherein the optical films and the adhesive layers are alternately stacked together.

37. The optical sheet set of claim 36 wherein the optical films have a structured surface.

38. The optical sheet set of claim 37 wherein each optical film is selected from the group consisting of light directing films, turning films, diffuser-type films, and multilayer optical films.

39. The optical sheet set of claim 37 wherein one adhesive layer contacts the structured surface of one optical film.

40. The optical sheet set of claim 36 and further comprising:
a liner stacked under the plurality of optical films and adhesive layers.

41. An optical sheet set comprising a plurality of stacked optical sheets, each optical sheet having an adhesive layer, and an optical film completely covering the adhesive layer, the optical film having at least one edge, and wherein the adhesive layer is recessed from the at least one edge of the optical film.

42. The optical sheet set of claim 41 wherein each optical film is selected from the group consisting of light directing films, turning films, diffuser-type films, and multilayer optical films.

43. The optical sheet set of claim 41 wherein the recess is a distance of between about 0.1 mm to about 1.0 mm.

44. The optical sheet set of claim 41 wherein the recess is a distance between about 0.1 mm to about 0.5 mm.

45. The optical sheet set of claim 41 wherein the recess is a distance that is larger than a shift length of misalignment between adjacent optical sheets.

46. An optical sheet set formed by a plurality of optical sheets comprising an optical film and an adhesive layer stacked so that outer edges of each adhesive layer are recessed from outer edges of adjacent optical films.

47. The optical sheet set of claim 46 wherein the adhesive layers have a frame-type shape.

48. The optical sheet set of claim 46 wherein the adhesive layers have a portion of a frame-type shape.

49. The optical sheet set of claim 46 wherein the outer edges of each adhesive layer are recessed from the outer edges of each adjacent optical film a distance that is larger than a shift length of misalignment between adjacent optical sheets.
